(19) United States
(12) Patent Application Publication
(10) Pub. No.: US 2020/0150812 A1
(43) Pub. Date: May 14, 2020

(54) INFORMATION-PROCESSING DEVICE AND INFORMATION-PROCESSING PROGRAM

(71) Applicant: PANASONIC INTELLECTUAL PROPERTY MANAGEMENT CO., LTD., Osaka (JP)

(72) Inventor: Takayoshi MORIYASU, Kanagawa (JP)

(73) Assignee: PANASONIC INTELLECTUAL PROPERTY MANAGEMENT CO., LTD., Osaka (JP)

(21) Appl. No.: 16/088,568

(22) PCT Filed: Feb. 17, 2017
(86) PCT No.: PCT/JP2017/005869

§ 371 Date: Sep. 26, 2018

(30) Foreign Application Priority Data
Mar. 29, 2016 (JP) 2016-065411

(51) Int. Cl. G06F 3/041; B60K 35/00; G06F 3/0488

(52) U.S. Cl. CPC G06F 3/0414; G06F 3/0418; B60K 2370/111; G06F 3/04883; B60K 2370/1434; B60K 35/00

(57) ABSTRACT

An information processing device includes a touch panel having a pressure-sensitive sensor. The pressure-sensitive sensor is an input device. The information processing device includes an input information acquisition unit and a controller. The input information acquisition unit acquires input information. The input information includes a position and pressing force of a touch operation performed on the touch panel. The controller accepts, when a first touch operation having the pressing force more than or equal to a threshold is performed, a second touch operation and selects at least one type of process from a plurality of types of processes based on at least a part of a movement locus of the second touch operation to execute the selected process.

### TECHNICAL FIELD

The present invention relates to an information processing device and an information processing program.

### BACKGROUND ART

In recent years, spread of smartphones has made an operation on a touch panel to be mainstream, and has decreased a number of input devices (for example, push-button switches) that are mounted separately from the touch panels. Further, as for an in-vehicle navigation device, a flat design such as a design of smartphones has been searched for and thus a number of input devices to be mounted separately from touch panels tends to be smaller similar to the case of smartphones.

From such a background, various user interfaces on touch panels are being examined. For example, PTL 1 discloses that operation buttons and operation bars are displayed as user interfaces on a touch panel, and while viewing a displayed image, a user can operate the operation buttons and the operation bars.

### CITATION LIST

### Patent Literature

PTL 1: Unexamined Japanese Patent Publication No. 2010-124120

### SUMMARY OF THE INVENTION

It is an object of the present invention to provide an information processing device and an information processing program that can implement more preferable user interfaces particularly in an in-vehicle navigation device.

The main invention is the information processing device in which a touch panel having a pressure-sensitive sensor is used as an input device. The information processing device includes an input information acquisition unit and a controller. The input information acquisition unit acquires input information. The input information includes a position and a pressing force of a touch operation performed on the touch panel. The controller accepts a second touch operation when a first touch operation having the pressing force more than or equal to a threshold is performed and selects at least one type of process from a plurality of types of processes based on at least a part of a movement locus of the second touch operation to execute the selected process.

The information processing device of the present invention enables a user to input a desired processing command without visually checking a display area of the touch panel and without performing detailed operations.

### BRIEF DESCRIPTION OF DRAWINGS

FIG. 1 is a diagram illustrating one example of an appearance of a navigation device according to a first exemplary embodiment.

FIG. 2 is a diagram illustrating one example of a hardware configuration of the navigation device according to the first exemplary embodiment.

FIG. 3 is a diagram illustrating one example of a functional block of a control device according to the first exemplary embodiment.

FIG. 4 is a development diagram illustrating a parts structure of a touch panel according to the first exemplary embodiment.

FIG. 5 is a cross-sectional view illustrating the parts structure of the touch panel according to the first exemplary embodiment.

FIG. 6 is a diagram illustrating one example of an operation flow of the navigation device according to the first exemplary embodiment.

FIG. 7A is a diagram illustrating one example of an operation mode for executing a process on the navigation device according to the first exemplary embodiment.

FIG. 7B is a diagram illustrating one example of an operation mode for executing a process on the navigation device according to the first exemplary embodiment.

FIG. 7C is a diagram illustrating one example of an operation mode for executing a process on the navigation device according to the first exemplary embodiment.

FIG. 7D is a diagram illustrating one example of an operation mode for executing a process on the navigation device according to the first exemplary embodiment.

FIG. 8 is a diagram illustrating one example of an operation flow of the navigation device according to a first modification of the first exemplary embodiment.

FIG. 9 is a diagram illustrating one example of an operation flow of the navigation device according to a second exemplary embodiment.

### DESCRIPTION OF EMBODIMENTS

A problem in a conventional device will briefly be described prior to description of exemplary embodiments of the present invention. A user interface for implementing a certain function is generally determined by assuming a use scene that a user utilizes the function. As for this point, in a case of an in-vehicle navigation device, since the user performs an operation such as changing in a volume of a music for a short time while waiting at a traffic light during driving, a user interface that makes the user concentrate on the operation might trigger an accident.

The above-described conventional technique in PTL 1 is for displaying a plurality of operation buttons on a display area of a touch panel and for making the user perform a selecting operation. For this reason, in a use mode in which a driver of a vehicle performs an operation, operability is not good and thus a misoperation might occur.

### First Exemplary Embodiment

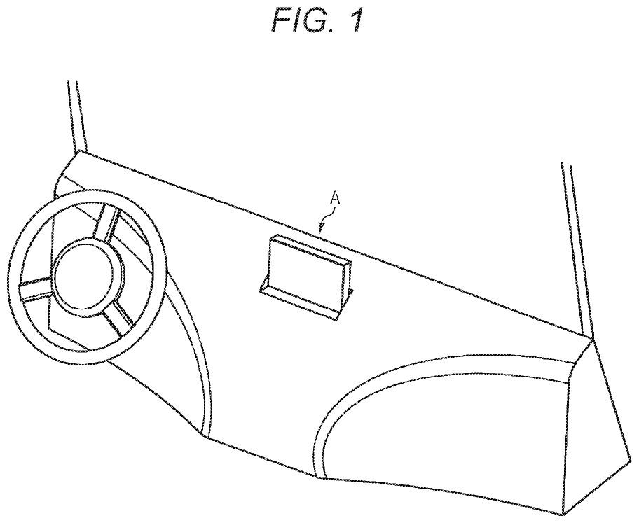

Hereinafter, an example of a configuration of an information processing device according to the present exemplary embodiment will be described with reference to FIG. 1 to FIG. 5. The information processing device according to the present exemplary embodiment is used in in-vehicle navigation device A (hereinafter abbreviated as “navigation device A”) that displays a navigation screen or the like.

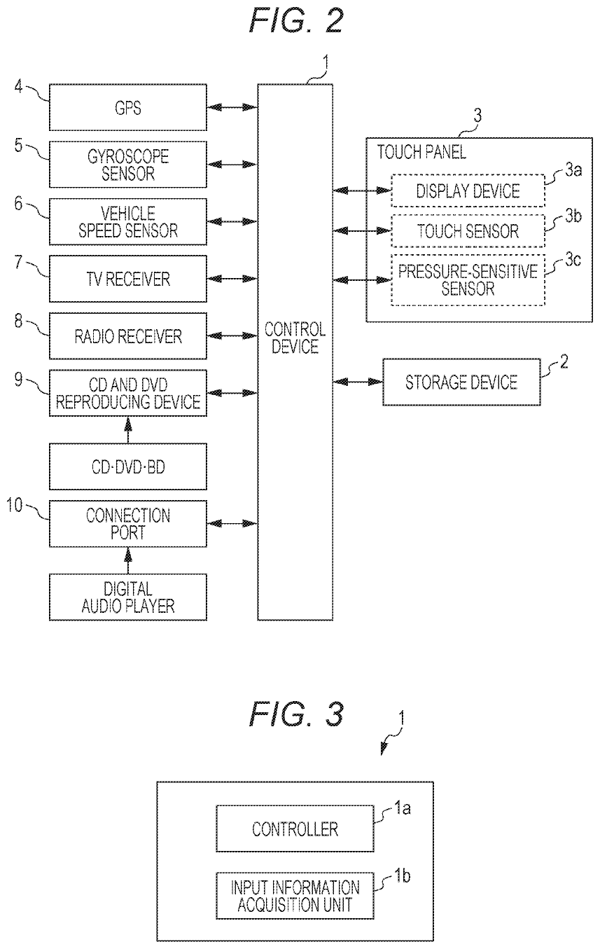

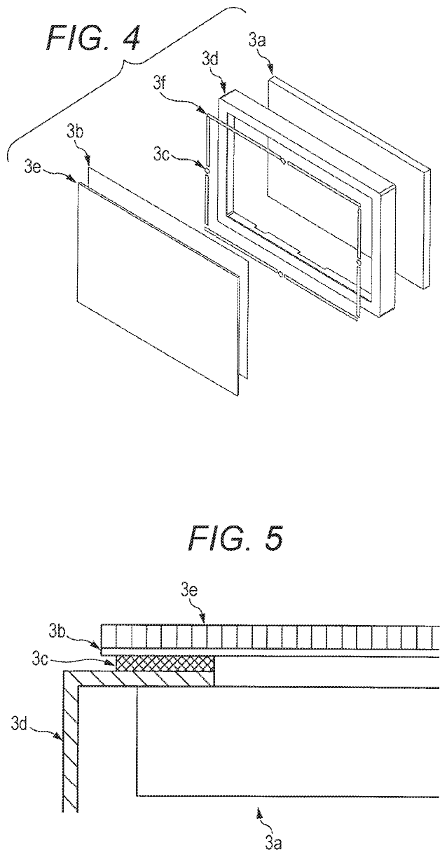

FIG. 1 is a diagram illustrating one example of an appearance of navigation device A according to the present exemplary embodiment. FIG. 2 is a diagram illustrating one example of a hardware configuration of navigation device A according to the present exemplary embodiment. FIG. 3 is a diagram illustrating one example of a functional block of control device 1 according to the present exemplary embodiment. FIG. 4 is an exploded perspective view illustrating a parts configuration of touch panel 3 according to the present exemplary embodiment. FIG. 5 is a cross-sectional view illustrating the parts configuration of touch panel 3 according to the present exemplary embodiment.

Navigation device A includes control device 1, storage device 2, touch panel 3, global positioning system (GPS) 4, gyroscope sensor 5, vehicle speed sensor 6, television (TV) receiver 7, radio receiver 8, compact disc (CD) and digital versatile disc (DVD) reproducing device 9, and connection port 10 for connecting a digital audio player.

Control device 1 (information processing device) includes, for example, a central processing unit (CPU). Control device 1 performs data communication with respective units of navigation device A by the CPU executing a computer program stored in storage device 2 to generally control the operations of the respective units.

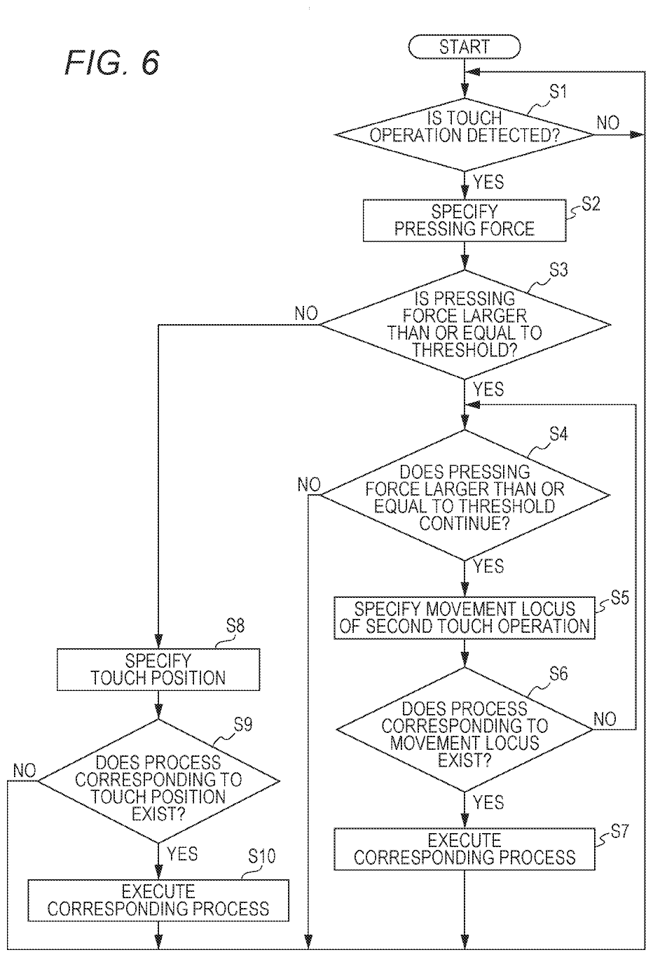

Control device 1 has functions of controller 1a and input information acquisition unit 1b. Controller 1a and input information acquisition unit 1b are implemented by, for example, the CPU executing an application program (see FIG. 3; details of the operations using these functions will be described later with reference to FIG. 6).

Controller 1a executes various processes according to a touch operation or the like to be performed by a user. For example, controller 1a executes a volume changing process for CD and DVD reproducing device 9 and a process for changing brightness of a display screen of display device 3a of touch panel 3. Controller 1a makes such control based on input information including a position and pressing force of the touch operation acquired by input information acquisition unit 1b.

Input information acquisition unit 1b acquires the input information including the position and the pressing force of the touch operation performed on touch panel 3. A signal indicating the position at a time of the touch operation is, for example, output from touch panel 3 (touch sensor 3b) to a register included in control device 1. Input information acquisition unit 1b acquires the input information about the position where the touch operation is performed, based on the signal stored in the register. In addition, a signal indicating the pressing force at the time of the touch operation is, for example, output as a voltage value from touch panel 3 (pressure-sensitive sensor 3c). Input information acquisition unit 1b acquires the input information about the pressing force in the touch operation, based on the voltage value.

When the application program is executed on an operating system program, input information acquisition unit 1b may acquire the input information about the position and the pressing force of the touch operation from the operating system program. For example, in accordance with acquisition of the signals indicating the position and pressing force of the touch operation from touch sensor 3b and pressure-sensitive sensor 3c through the operating system program, input information acquisition unit 1b may acquire the data from the operating system program in an event-driven manner.

In this case, the pieces of input information about the position and pressing force of the touch operation are specified based on the signals output from touch sensor 3b and pressure-sensitive sensor 3c (to be described later). However, as a matter of course, another method may be adopted as long as the position and pressing force of the touch operation can be specified. For example, input information acquisition unit 1b may specify the position of the touch operation based on a balance of the pressing force acquired from a plurality of pressure-sensitive sensors 3c (FIG. 4) (to be described later).

Note that the functions of controller 1a and input information acquisition unit 1b may be implemented by cooperation of a plurality of computer programs with each other using an application programming interface (API) or the like.

Storage device 2 includes, for example, a read only memory (ROM), a random access memory (RAM), and a hard disk drive (HDD). Various processing programs such as an operating system program and an application program executable on the operating system program are non-transitorily stored in storage device 2, and various types of data are stored in storage device 2. Further, a work area for non-transitory storage in a calculating process is formed in storage device 2. In storage device 2, the data or the like may be stored in an auxiliary storage device such as a flash memory in readable and rewritable manners. In addition, according to the position of a vehicle or a request by the touch operation, these programs and these pieces of data may successively be downloaded through an internet line, and stored in storage device 2.

Further, for example, storage device 2 includes pieces of image data such as a navigation screen for displaying a map image and a frequency modulation (FM) screen for listening to an FM radio. Data relating to an icon and the like displayed in the screen is also attached to the pieces of image data, and a user can perform a corresponding process according to the position selected in the screen.

Touch panel 3 includes display device 3a, touch sensor 3b, and pressure-sensitive sensor 3c (see FIGS. 4 and 5).

For example, display device 3a is configured with a liquid crystal display, and the navigation screen is displayed in a display area of the liquid crystal display. Display device 3a receives the image data for displaying the navigation screen and the like from control device 1, and displays the navigation screen and the like based on the image data. Further, display device 3a changes brightness of the display screen (for example, an output light amount of a backlight) based on a control signal from control device 1, or changes a scale of a map image on the navigation screen (for example, acquires image data of the map image with the changed scale from storage device 2, based on map coordinates of the map image currently displayed).

Touch sensor 3b is a sensor that configures an input device for a user operating navigation device A. Touch sensor 3b detects a position touched on the display area of display device 3a. For example, a projection type electrostatic capacitance touch sensor is used as touch sensor 3b, and a plurality of electrostatic capacitance sensors are formed in a matrix form on the display area of display device 3a by X-electrodes and Y-electrodes arrayed in a matrix form. Touch sensor 3b detects a change in electrostatic capacitance due to capacitive coupling generated between these electrodes and a finger when the finger comes close to touch sensor 3b using the electrostatic capacitance sensor, and detects the position where the touch operation is performed based on a detection result of the change in electrostatic capacitance. The detection signal is output as a signal indicating the position where the touch operation is performed to control device 1. The position detected by touch sensor 3b may be subjected to a correcting process so as to be matched with each position of the display area of display device 3a.

Pressure-sensitive sensor 3c is a sensor configuring the input device with which the user performs the input to navigation device A. Pressure-sensitive sensor 3c detects the pressing force in the touch operation on the display area of display device 3a. For example, a sensor in which a resistance value changes according to contact pressure is used as pressure-sensitive sensor 3c, and pressure-sensitive sensor 3c detects the pressing force in the touch operation by converting a change of the resistance value into a voltage value. Pressure-sensitive sensor 3c is disposed in four places corresponding to four sides on a periphery of the display area of display device 3a. A signal indicating the pressing force in the touch operation detected by pressure-sensitive sensor 3c is output to control device 1.

Touch panel 3 includes housing 3d, cover lens 3e, and double sided tape 3f in addition to above-described display device 3a, touch sensor 3b, and pressure-sensitive sensor 3c.

Specifically, in touch panel 3, display device 3a is accommodated in housing 3d such that the display area is exposed, and plate-shaped touch sensor 3b and cover lens 3e are disposed in this order so as to cover the display area of display device 3a. Plate-shaped touch sensor 3b is fixed to housing 3d using double sided tape 3f on an outside of an outer edge of the display area of display device 3a. Pressure-sensitive sensors 3c are disposed between plate-shaped touch sensor 3b and housing 3d on the outer periphery of the display area of display device 3a. When the user performs the touch operation on touch panel 3, the user performs the touch operation on a surface of cover lens 3e.

GPS 4, gyroscope sensor 5, vehicle speed sensor 6, TV receiver 7, radio receiver 8, CD and DVD reproducing device 9, connection port 10 for connecting a digital audio player can perform data communication with control device 1 as described above. For example, CD and DVD reproducing device 9 (a sound output device or a data reproducing device) and the digital audio player changes output volumes or changes a reproducing point of music data based on a control signal from control device 1. These devices are publicly-known, so that the detailed description will be omitted.

<Operation of Navigation Device A>

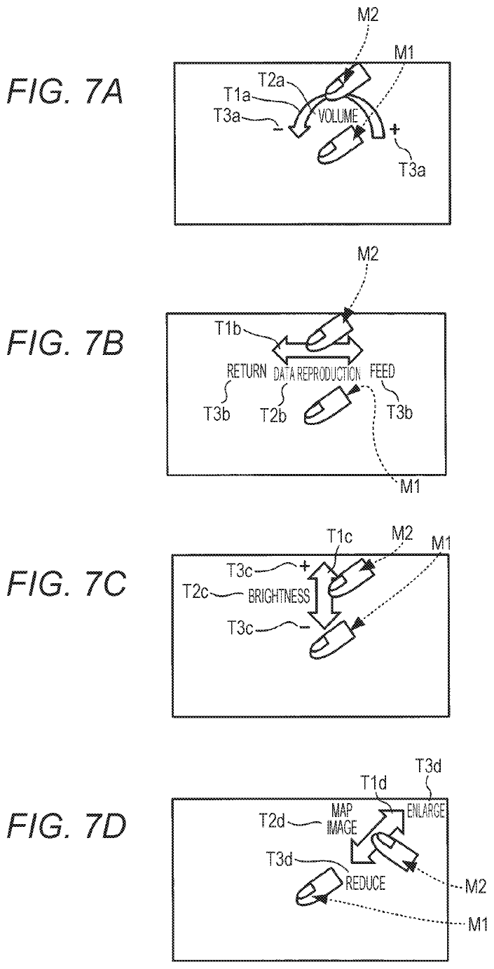

One example of an operation of navigation device A will be described below with reference to FIG. 6 to FIG. 7D.

FIG. 6 is a diagram illustrating one example of an operation flow of navigation device A according to the present exemplary embodiment. This operation flow is performed by control device 1, and is implemented by, for example, control device 1 executing a process according to the application program. Particularly, an acceptance process in the input operation to be performed by controller 1a will be described below.

FIG. 7A to FIG. 7D are diagrams illustrating examples of an operation mode for executing the process on navigation device A according to the present exemplary embodiment (hereinafter, referred to as a “template locus”). FIG. 7A illustrates a change operation for an output volume of CD and DVD reproducing device 9 (sound output device). FIG. 7B illustrates a change operation of a music data reproducing position of CD and DVD reproducing device 9 (data reproducing device). FIG. 7C illustrates an operation for changing brightness of a display screen on display device 3a. FIG. 7D illustrates an operation for changing a scale of an image (for example, a map image or a photographic image) to be displayed by display device 3a.

As illustrated in FIG. 7A to FIG. 7D, the user interface according to the present exemplary embodiment is characterized by an input operation using two fingers. Hereinafter, in a state that touch panel 3 is not touched by the other fingers, the touch operation when touching is referred to as a “first touch operation” (in the drawings, M1). In a state that first touch operation M1 is performed, the touch operation performed by the other fingers is referred to as a “second touch operation” (in the drawing, M2). In FIG. 7A to FIG. 7D, symbols T1a to T1d indicate template loci for causing controller 1a to execute predetermined processes. Symbols T2a to T2d indicate types of processes to be executed according to the template loci. Symbols T3a to T3d indicate a + direction and a − direction in a process to be executed by controller 1a.

Herein, the operation flow of navigation device A will be described with reference to FIG. 6.

When the application program is executed, controller 1a reads, for example, position data of a vehicle acquired by GPS 4. As a result, controller 1a creates a map image from map coordinates corresponding to the position data of the vehicle such that the position of the vehicle comes around a center of the display area.

In a state that the application program is being executed, controller 1a waits for the user performing first touch operation M1 on touch panel 3 as illustrated in FIG. 6 (NO in step S1). For example, first touch operation M1 to be performed by the user is determined in a manner that input information acquisition unit 1b monitors a signal that is input from touch sensor 3b into control device 1.

If first touch operation M1 is performed on touch panel 3 (YES in step S1), input information acquisition unit 1b first acquires a signal from pressure-sensitive sensor 3c and specifies the pressing force of first touch operation M1 (step S2).

Controller 1a determines whether the pressing force specified by input information acquisition unit 1b is more than or equal to a threshold (step S3). If the pressing force is determined to be less than the threshold (NO in step S3), a normal touch operation is performed in following steps S8 to S10. If the pressing force is determined to be more than or equal to the threshold (YES in step S3), not the normal operation but the process in following steps S4 to S7 is performed.

When controller 1a determines that the pressing force in first touch operation M1 is less than the threshold (NO in step S3), input information acquisition unit 1b specifies the touch position on the display area of touch panel 3 in first touch operation M1 based on a signal from touch sensor 3b (step S8). Controller 1a then determines whether a process corresponding to the touch position in first touch operation M1 specified by input information acquisition unit 1b exists (step S9). If the process corresponding to the touch position in first touch operation M1 exists (YES in step S9), (for example, if a navigation screen is displayed, a map image is moved), controller 1a executes the process (step S10), and the process returns to the waiting state in step S1 again. On the other hand, if the process corresponding to the touch position in first touch operation M1 does not exist (NO in step S9), controller 1a does not execute any particular process and returns to the waiting state in step S1 again.

On the other hand, if controller 1a determines that the pressing force of first touch operation M1 is more than or equal to the threshold (YES in step S3), controller 1a is brought into a state for accepting following second touch operation M2. In this state, controller 1a continuously accepts following second touch operation M2 until the pressing force of first touch operation M1 becomes less than the threshold (YES in step S4). If the pressing force of first touch operation M1 is less than the threshold (NO in step S4), controller 1a does not execute any particular process to return to the waiting state in step S1 again.

In step S4, if first touch operation M1 is once performed with the pressing force more than or equal to the threshold, a process relating to the normal touch operation (step S10) is not executed so that a misoperation is prevented. In other words, controller 1a accepts first touch operation M1 and second touch operation M2 in any position on the display area of touch panel 3. For this reason, when the process proceeds to steps S8 to S10, controller 1a may incorrectly execute the process relating to the touch operation unintended by the user. In step S4, such a misoperation is prevented.

Input information acquisition unit 1b then specifies a movement locus of second touch operation M2 (step S5). The movement locus of second touch operation M2 means a movement direction and a movement distance of the touch operation formed by a temporal change in the touch position. The movement locus of second touch operation M2 is specified, for example, in a manner that input information acquisition unit 1b sequentially acquires a signal indicating the touch position from touch sensor 3b for a constant time (for example, 0.5 seconds). Data regarding the movement locus of second touch operation M2 is retained while the pressing force of first touch operation M1 continues to be more than or equal to the threshold.

Controller 1a determines whether a process corresponding to the movement locus of second touch operation M2 specified by input information acquisition unit 1b exists (step S6). If the process corresponding to the movement locus of second touch operation M2 does not exist (NO in step S6), controller 1a returns to step S4 and then continues detecting and specifying the movement locus of second touch operation M2. On the other hand, if the process corresponding to the movement locus of second touch operation M2 exists (YES in step S6), controller 1a receives an execution command for the process and executes the corresponding process (step S7).

In step S6, controller 1a determines, for example, whether the process corresponds to any one of preset template loci illustrated in FIG. 7A to FIG. 7D. Controller 1a selects the corresponding template locus and executes the process. At this time, controller 1a may make the determination based on only a movement distance to a predetermined direction on the movement locus of second touch operation M2. Alternatively, controller 1a may make the determination by calculating similarity between the movement locus of second touch operation M2 and the template loci through template matching or the like. In step S6, controller 1a determines, based on the movement locus of second touch operation M2 regardless of the position where second touch operation M2 is performed, whether an execution command for a corresponding process is issued. As a result, the user can perform the input operation without moving a visual line to the display area of touch panel 3.

In step S6, for example, an arc-shaped swipe operation is performed in second touch operation M2 to change an output volume (FIG. 7A). At this time, when the movement locus of second touch operation M2 is the swipe operation for drawing an arc to a left direction, controller 1a executes a process for reducing the output volume by one stage. When the movement locus of second touch operation M2 is the swipe operation for drawing an arc to a right direction, controller 1a executes a process for increasing the output volume by one stage (step S7).

Controller 1a of navigation device A according to the present exemplary embodiment discriminates the normal touch operation for executing the process corresponding to the touch position from the operations including changing the output volume illustrated in FIG. 7A to FIG. 7D through first touch operation M1 with the pressing force more than or equal to the threshold. In a case of the operation for changing the output volume, controller 1a accepts second touch operation M2 on any position of touch panel 3, and selects at least one process from a plurality of types of processes based on the movement locus of second touch operation M2 to execute the selected process. For this reason, the user can input a desired processing command without viewing the display area of touch panel 3 and without performing detailed operations.

In addition, since navigation device A according to the present exemplary embodiment does not have to display a plurality of operation buttons on the display area of touch panel 3, the display area of touch panel 3 can be effectively used. Therefore, the user interface can preferably be used particularly in an in-vehicle navigation device.

### First Modification of First Exemplary Embodiment

The above exemplary embodiment has described the mode that controller 1a causes a changing amount to change by one stage when changing the output volume in second touch operation M2. Controller 1a desirably executes the changing process for the output volume such that as the position of second touch operation M2 at a time of executing the output volume changing process is farther from a starting position of second touch operation M2, the changing amount is larger.

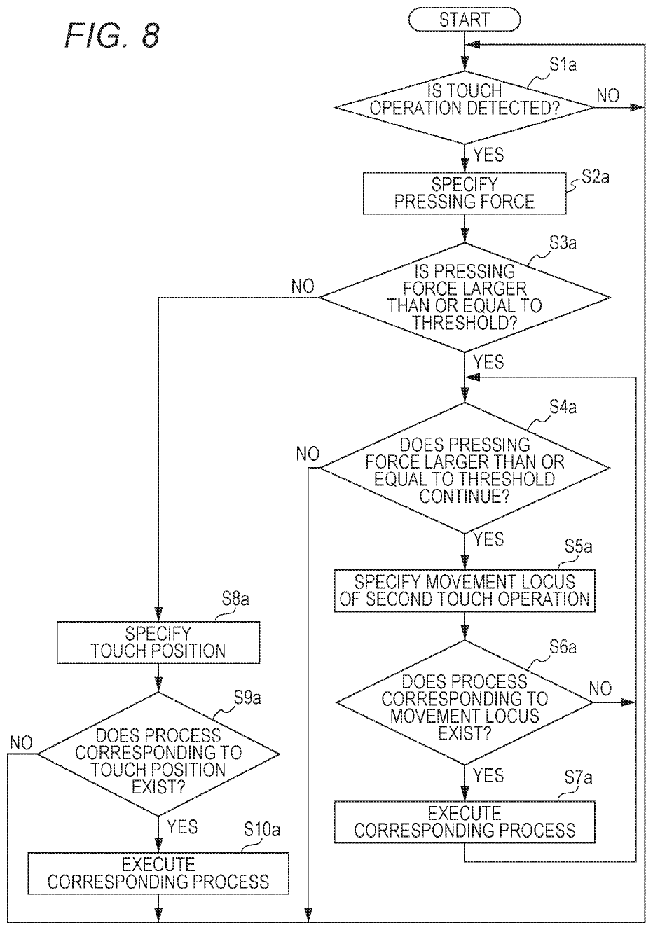

FIG. 8 is a diagram corresponding to FIG. 6, and illustrates another example of the operation flow of navigation device A. In FIG. 8, only a process in step S7a is different from the operation flow illustrated in FIG. 6. In other words, processes to be executed in steps S1a to S6a, and steps S8a to S10a are similar to the processes to be executed in steps S1 to S6 and steps S8 to S10 in the operation flow of FIG. 6, respectively. Note that the description about other parts common to those in the first exemplary embodiment will be omitted (hereinafter, the same applies to other exemplary embodiments).

As illustrated in FIG. 8, in a process in step S7a, after controller 1a executes the process corresponding to the movement locus of second touch operation M2, controller 1a returns to step S4a again. At this time, controller 1a resets, for example, data regarding the movement locus of second touch operation M. Controller 1a and input information acquisition unit 1b continuously repeat steps S4a to S7a while first touch operation M1 of the pressing force more than or equal to the threshold is being performed. As a result, controller 1a can determine the changing amount in the process to be executed, based on a movement amount of the movement locus of second touch operation M2.

Controller 1a may retain the data regarding the movement locus of second touch operation M instead of resetting the data, and sequentially execute the process in step S7a based on the movement locus of continuing second touch operation M such that the changing amount corresponds to the movement amount. Controller 1a may, for example, determine the changing amount of the output volume based on a separation distance from a touch position where second touch operation M starts to the touch position of second touch operation M at a time of executing the process in step S7a toward a predetermined direction.

Further, controller 1a may retain data in the type of the process previously selected (for example, the process for changing the output volume) while first touch operation M1 of the pressing force more than or equal to the threshold is being detected, and may lock to accept only a process equal to this type of the process in step S6a. As a result, an unintended process is not executed.

Further, after controller 1a executes the output-volume changing process in step S7a, a constant interval time (for example, 0.5 seconds) may be inserted. As a result, it is possible to prevent the output volume changing process and the like in step S7a from being sequentially executed and therefore the output volume abruptly increases.

As the position of second touch operation M2 at the time of executing the output-volume changing process and the like is farther from the starting position of second touch operation M2, the changing amount is made to be larger. In order to implement this, for example, a template locus corresponding to one type of a process may be provided for each separation amount from the starting position of second touch operation M2. For example, as the template locus corresponding to the output-volume changing process, a template locus for changing the output volume by one stage is provided correspondingly to a case where the separation amount from the starting position of second touch operation M2 is small. Further, a template locus for changing the output volume by two stages is provided correspondingly to a case where the separation amount from the starting position of second touch operation M2 is large.

In this case, in step S6 of FIG. 6, when the separation amount from the starting position of second touch operation M2 is small, controller 1a selects the template locus for changing the output volume by one stage. When the separation amount from the starting position of second touch operation M2 is large, controller 1a selects the template locus for changing the output volume by two stages. As a result, controller 1a can execute the process in step S7 such that as the position of second touch operation M2 at the time of executing the output-volume changing process and the like is farther from the starting position of second touch operation M2, the changing amount is larger.

As described above, in navigation device A according to the first modification, the user can execute the process such that a desired changing amount is obtained through one operation (for example, a swipe operation). For this reason, operability at a time of changing the output volume in a sound output device can be further improved.

### Second Modification of First Exemplary Embodiment

When the user performs second touch operation M2, it is desirable that controller 1a further displays an identification mark for making the user easily check the process to be executed correspondingly to the movement locus.

Specifically, if controller 1a determines that the movement locus of second touch operation M2 matches any of the plurality of template loci in step S5 of FIG. 6, controller 1a causes a type of the process corresponding to the template locus to be displayed on touch panel 3 discriminably. Examples of the identification mark are template loci T1a to T1d for causing controller 1a to execute a predetermined process, types of processes T2a to T2d to be executed correspondingly to the template loci, and + directions and − directions T3a to T3d in the process to be executed, in FIG. 7A to FIG. 7D. These marks are displayed as images.

For example, when the movement locus of second touch operation M2 corresponds to the operation for changing the output volume, as illustrated in FIG. 7A, controller 1a displays arrow T1a indicating the template locus, character T2a indicating the operation for changing the output volume, and the + and − directions to be displayed as identification marks T3a on touch panel 3. As for the identification mark, for example, a corresponding image is displayed on touch panel 3 by using image data stored in advance in storage device 2.

As described above, in navigation device A according to the second modification, when the movement locus of second touch operation M2 is a movement locus for executing any type of process in the plurality of types of processes, controller 1a displays an identification mark for identifying the type on touch panel 3. As a result, the user can check the type of the process input in second touch operation M2.

### Third Modification of First Exemplary Embodiment

When first touch operation M1 of the pressing force more than or equal to the threshold is detected, controller 1a desirably displays identification marks for easily identifying the template locus and the process corresponding to the template locus when the user performs second touch operation M2.

Specifically, when first touch operation M1 of the pressing force more than or equal to the threshold is detected in step S3 of FIG. 6, controller 1a relates a character image indicating the type with an image of the template locus and displays at least one type on touch panel 3 discriminably. Examples of the identification mark are template loci T1a to T1d for causing controller 1a to execute a predetermined process, types of processes T2a to T2d to be executed correspondingly to the template loci, and + directions and − directions T3a to T3d in the process to be executed, in FIG. 7A to FIG. 7D. These marks are displayed as images.

In such a manner, the user can check how to draw the movement locus of second touch operation M2 in order to cause controller 1a to execute a desired process when performing second touch operation M2.

### Second Exemplary Embodiment

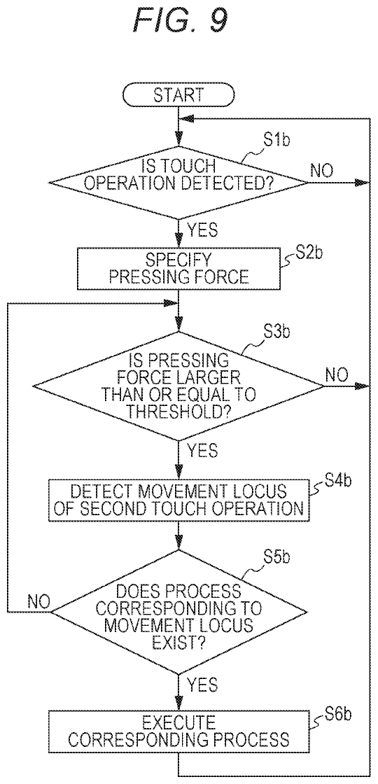

Next, with reference to FIG. 9, an information processing device according to a second exemplary embodiment will be described. The information processing device is different between the present exemplary embodiment and the first exemplary embodiment in that when first touch operation M1 generates the pressing force less than the threshold, controller 1a cancels information to be input into touch panel 3.

FIG. 9 corresponds to FIG. 6, and illustrates another example of an operation flow of navigation device A.

The operation flow illustrated in FIG. 9 is different from the operation flow illustrated in FIG. 6 only in that when first touch operation M1 generates the pressing force less than the threshold in step S3b, the operation flow returns to the state of waiting for the touch operation in step S1b without executing any particular process. In other words, the processes to be executed in steps S1b to S2b and steps S4b to S6b are similar to the processes to be executed in steps S1 to S2, and steps S5 to S7 in the operation flow of FIG. 6, respectively.

In such a manner, when first touch operation M1 generates the pressing force less than the threshold, controller 1a can cancel the input information even if the user performs any touch operation on touch panel 3.

In in-vehicle navigation device A, when the user moves his/her hand for searching for a certain thing in a vehicle, the user might incorrectly touch touch panel 3. For this reason, it is desirable that such a case is discriminated as a misoperation, and this touch operation is not accepted. Further, in in-vehicle navigation device A, a use mode in which the user performs the input operation is limited to, for example, the operation for changing a scale of a map image on the navigation screen and the operation for changing the output volume of CD and DVD reproducing device 9.

Therefore, controller 1a according to the present exemplary embodiment discriminates whether an input operation is performed intentionally by the user in a state that first touch operation M1 to be performed with the pressing force more than or equal to the threshold is a condition of the input operation to discriminate an operation type in second touch operation M2. This configuration can prevent the user from performing a misoperation caused by touching touch panel 3 unconsciously.

Note that controller 1a may acquire, for example, a signal indicating whether the user is driving from a vehicle engine control unit (ECU), and when the user is driving, controller 1a may cancel first touch operation M1 of the pressing force less than the threshold. As a result, induction of an accident can be prevented during the driving, and the operability of character input or the like during stop of the driving can be improved.

As described above, navigation device A according to the present exemplary embodiment is configured such that when first touch operation M1 generates the pressing force less than the threshold, the input information of first touch operation M1 and second touch operation M2 is cancelled. For this reason, this configuration can prevent the user from touching touch panel 3 unconsciously and performing a misoperation.

### OTHER EXEMPLARY EMBODIMENTS

Although specific examples of the present invention are described above in detail, they are mere exemplifications and do not limit the scope of claims. The technique described in the claims includes various variations and changes of the specific examples exemplified above.

For example, in the process for determining whether the process corresponding to the movement locus of second touch operation M2 exists (in step S6 of FIG. 6), controller 1a determines whether at least a part of the continuous movement locus of second touch operation M2 matches any of the template loci to execute a process corresponding to the matched template locus.

Further, in this determination process (step S6 of FIG. 6), controller 1a may execute only one type of process or a plurality of types of processes based on the movement locus of second touch operation M2. On the other hand, when the movement locus of second touch operation M2 matches the plurality of template loci, controller 1a may execute a determination process for extracting only one type of process.

Further, the above exemplary embodiments have described, as one example of the process to be executed by controller 1a, the process for changing the output volume of the sound output device, the process for changing a data reproducing point of the data reproducing device, the process for changing brightness of the display screen in the display device, and the process for changing a scale of a display image. However, obviously the process to be executed by controller 1a can be applied to other processes. For example, the process to be executed by controller 1a can be applied also to a process for switching a screen currently displayed by display device 3a into another screen, a process for selecting an application to be executed, and the like.

At least the following matter will be apparent from the description of the specification and the accompanying drawings.

According to one aspect of the disclosure, information processing device 1 includes touch panel 3 having pressure-sensitive sensor 3c. pressure-sensitive sensor 3c is an input device. Information processing device 1 includes input information acquisition unit 1b and controller 1a. Input information acquisition unit 1b acquires input information. The input information includes a position and pressing force of a touch operation performed on touch panel 3. Controller 1a, when first touch operation M1 having the pressing force more than or equal to a threshold is performed, accepts second touch operation M2 and selects at least one type of process from a plurality of types of processes based on at least a part of a movement locus of second touch operation M2 to execute the selected process. Information processing device 1 can cause a user to input a desired processing command without visually checking a display area of touch panel 3 and without performing detailed operations.

In information processing device 1, when first touch operation M1 generates pressing force less than the threshold, controller 1a may cancel the input information of first touch operation M1 and second touch operation M2. Information processing device 1 can prevent the user from touching touch panel 3 unconsciously and performing a misoperation.

Further, in information processing device 1, the plurality of types of processes may include at least one of the process for changing the output volume from sound output device 9, the process for changing a data reproducing point of sound output device 9, the process for changing brightness of the display screen on display device 3a, and the process for changing an image to be displayed by display device 3a.

Further, in information processing device 1, controller 1a may execute a selected process such that as the position of the second touch operation at the time of executing the selected process is farther from the starting position of the second touch operation, the changing amount is larger. Information processing device 1 can cause the user to execute the process through one operation (for example, the swipe operation) such that a desired changing amount is obtained.

Further, in information processing device 1, when first touch operation M1 having the pressing force more than or equal to the threshold continues, controller 1a may continuously execute the selected process based on at least a part of the movement locus of second touch operation M2.

Further, in information processing device 1, when at least a part of the movement locus of second touch operation M2 matches the movement locus for executing any of the plurality of types of processes, controller 1a may display identification marks T2a to T2d for identifying the types of processes corresponding to the movement locus on touch panel 3. Information processing device 1 can cause the user to check the type of the process input in second touch operation M2.

Further, in information processing device 1, when first touch operation M1 having the pressing force more than or equal to the threshold is performed, controller 1a may display identification marks T2a to T2d and T1a to T1d for identifying a movement locus for executing at least one process in the plurality of types of processes in the second touch operation and a type corresponding to the movement locus on touch panel 3. Information processing device 1 can cause the user to check how to draw a movement locus in second touch operation M2 in order to execute a desired process.

Further, information processing device 1 may be mounted on the in-vehicle navigation device.

According to another aspect of the disclosure, an information processing program is to be executed by a computer including touch panel 3 having pressure-sensitive sensor 3c. Touch panel 3 is an input device. The information processing program includes acquiring input information. The input information including a position and pressing force of a touch operation performed on touch panel 3. The information processing program also includes accepting, when first touch operation M1 having the pressing force more than or equal to a threshold is performed, second touch operation M2, and selecting at least one type of process from a plurality of types of processes based on at least a part of a movement locus of second touch operation M2 to execute the selected process.

### INDUSTRIAL APPLICABILITY

The information processing device of the present disclosure can implement, for example, a more preferable user interface in an in-vehicle navigation device.

### REFERENCE MARKS IN THE DRAWINGS

A: navigation device
1: control device (information processing device)
2: storage device
3: touch panel
4: GPS
5: gyroscope sensor
6: vehicle speed sensor
7: TV receiver
8: radio receiver
9: CD and DVD reproducing device (sound output device, data reproducing device)
10: connection port
1a: controller
1b: input information acquisition unit
3a: display device
3b: touch sensor
3c: pressure-sensitive sensor
3d: housing
3e: cover lens
3f. double sided tape

1. An information processing device including a touch panel having a pressure-sensitive sensor, the touch panel being an input device, the information processing device comprising:
an input information acquisition unit that acquires input information, the input information including a position and pressing force of a touch operation performed on the touch panel; and
a controller that accepts, when a first touch operation having the pressing force more than or equal to a threshold is performed, a second touch operation and selects at least one type of process from a plurality of types of processes based on at least a part of a movement locus of the second touch operation to execute the at least one type of process.

2. The information processing device according to claim 1, wherein when the first touch operation generates pressing force less than the threshold, the controller cancels input information of the first touch operation and the second touch operation.

3. The information processing device according to claim 1, wherein the plurality of types of processes includes at least any one of a process for changing an output volume of a sound output device, a process for changing a data reproduction point of a data reproducing device, a process for changing brightness of a display screen of a display device, and a process for changing an image to be displayed by the display device.

4. The information processing device according to claim 3, wherein the controller executes the at least one type of process such that as a position of the second touch operation at a time of executing the at least one type of process is farther from a starting position of the second touch operation, a changing amount is larger.

5. The information processing device according to claim 1, wherein when the first touch operation having the pressing force more than or equal to the threshold continues, the controller successively executes the at least one type of process based on at least a part of the movement locus of the second touch operation.

6. The information processing device according to claim 1, wherein when at least the part of the movement locus of the second touch operation matches a movement locus for executing any of the plurality of types of processes, the controller displays an identification mark for identifying a type corresponding to the movement locus on the touch panel.

7. The information processing device according to claim 1, wherein when the first touch operation having the pressing force more than or equal to the threshold is performed, the controller displays identification marks for identifying a movement locus for executing at least one process in the plurality of types of processes through the second touch operation and a type of process corresponding to the movement locus on the touch panel.

8. The information processing device according to claim 1 to be mounted in an in-vehicle navigation device.

9. An information processing program to be executed by a computer, the computer including a touch panel having a pressure-sensitive sensor, the touch panel being an input device, the information processing program comprising:
acquiring input information, the input information including a position and pressing force of a touch operation performed on the touch panel; and
accepting, when a first touch operation having the pressing force more than or equal to a threshold is performed, a second touch operation and selecting at least one type of process from a plurality of types of processes based on at least a part of a movement locus of the second touch operation to execute the at least one type of process.
